(19) United States
(12) Patent Application Publication
(10) Pub. No.: US 2014/0357095 A1
(43) Pub. Date: Dec. 4, 2014

(54) BLOCK CONNECTOR HOLDER

(71) Applicant: TOYOTA MOTOR ENGINEERING & MANUFACTURING NORTH AMERICA, INC., Ann Arbor, MI (US)

(72) Inventor: Mahendra Tukaram Kute, Northville, MI (US)

(21) Appl. No.: 13/908,539

(22) Filed: Jun. 3, 2013

(51) Int. Cl. H01R 13/518

(52) U.S. Cl. CPC H01R 13/518
USPC 439/34; 439/540.1

(57) ABSTRACT

A block connector holder includes a housing having an exterior surface having one or more exterior attachment structures and an interior surface, opposite the exterior surface, defining an interior space, the interior surface including an interior attachment structure. An electrical component is attachable to each of the one or more exterior attachment structures and the interior attachment structure.

### TECHNICAL FIELD

The present disclosure generally relates to a block connector holder and, more specifically, to a housing for retaining and supporting multiple modular wire harness block connectors.

### BACKGROUND

Modern vehicles include many features that require the transmission of electrical power, and thus, dozens or even hundreds of electrical wires. Wire harnesses are used to bind together many wires to organize the wires, conserve space, increase the ease of installation, and protect against the adverse effects of vibrations, abrasions, and moisture.

Wire harnesses are oftentimes secured to apertures or other openings in a vehicle using clips or other means of attachment. Furthermore, it is not uncommon for automotive vehicles to include many wire harnesses in a small area where it is difficult to provide for attachment points or otherwise secure the wire harnesses to the vehicle.

Accordingly, a need exists for retaining and supporting multiple electrical components such as wire harnesses within a small area in the interior of an automotive vehicle.

### SUMMARY

The present invention includes many aspects and features. Moreover, while many aspects and features related to, and are described in, the context of a vehicle wire management device, the present invention is not limited to use only in this context, as will become apparent from the following summaries and detailed descriptions of aspects, features, and one or more embodiments of the present invention.

Accordingly, a first aspect of the present invention related to a block connector holder. An exemplary block connector holder includes a housing having an exterior surface having one or more exterior attachment structures and an interior surface, opposite the exterior surface, defining an interior space, the interior surface including an interior attachment structure. Furthermore, an electrical component is attachable to each of the one or more exterior attachment structures and the interior attachment structure.

In a feature of this aspect of the invention, the block connector holder includes a housing attachment structure on the exterior surface. The housing attachment structure may be removably attachable to an attachment component on a surface to secure the block connector holder to the surface. In a variation, the housing attachment structure is slidably attachable to the attachment component. In yet another variation, the housing attachment structure is a female-type attachment structure. In still another variation, the attachment component is a trim clip.

In other features of this aspect of the invention the housing may be parallelepiped in shape, the exterior surface may include exactly three exterior attachment structures, each of the one or more exterior attachment structures may be removably attachable to a block connector, and the interior attachment structure may be removably attachable to a block connector such that the attached block connector is generally disposed within the interior space.

A second aspect of the present invention relates to a vehicle. An exemplary such vehicle includes a vehicle interior including an attachment point, and a block connector holder. The block connector includes an exterior surface having one or more exterior attachment structures, and an interior surface having an interior attachment structure. An electrical component is attachable to each of the interior attachment structure and the one or more exterior attachment structures, and the block connector holder is attachable to the attachment point.

In a feature of this aspect of the invention, the vehicle may include an attachment component, wherein the attachment component connects an exterior attachment structure of the one or more exterior attachment structures to the attachment point. The attachment structure may be a clip-like structure.

A third aspect of the present invention relates to a block connector assembly. An exemplary block connector assembly includes an attachment component affixed to a vehicle, the attachment component including a first housing attachment structure, a block connector holder including an exterior surface having a second housing attachment structure and one or more exterior electrical component attachment structures and an interior surface opposite the exterior surface, the interior surface including an interior electrical component attachment structure, and an electrical component. The block connector holder is removably attachable to the attachment component by attaching the first housing attachment structure to the second housing attachment structure. Furthermore, the electrical component is removably attachable to the block connector holder by attaching the electrical component to one of either the interior electrical component attachment structure or the one or more exterior electrical component attachment structures.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is an isometric view of a block connector holder in accordance with one or more preferred embodiments of the present invention and described herein;

FIG. 2 is an exploded view of the block connector holder of FIG. 1;

FIG. 3 is an isometric view of the block connector holder of FIG. 1 including arrows indicating the direction of attachment of block connectors to the block connector holder;

FIG. 4 is a right side view of the block connector holder of FIG. 1, including an attachment point aligned and disengaged from an exterior attachment structure;

FIG. 5 is a cross-sectional view of the attachment point and the exterior attachment structure of FIG. 4, taken along line 5-5;

FIG. 6 is a right side view of the block connector holder of FIG. 1, including an attachment point engaged with an exterior attachment structure;

FIG. 7 is a cross-sectional view of the attachment point and the exterior attachment structure of FIG. 6, taken along line 7-7;

FIG. 8 is a front view of a block connector holder in accordance with an embodiment of the present invention; and

FIG. 9 is a front view of two block connector holders in accordance with an embodiment of the present invention.

### DETAILED DESCRIPTION

Generally, a block connector holder in accordance with one or more embodiments of the present invention comprises a housing, a housing attachment structure for attaching the housing to an attachment point in an automotive vehicle, and one or more attachment structures, each of the one or more attachment structures being configured to secure a component such as an electrical component, a wiring harness, or a block connector to the housing. Use of a block connector holder in accordance with one or more embodiments of the present invention provides several benefits. For example, the block connector holder can be used to save space within a vehicle by allowing multiple electrical components to be connected to a single attachment point within the vehicle. Additionally, use of the block connector holder can save on material costs by reducing the number of trim clips and clamps needed to secure electrical components to the vehicle. Furthermore, use of the block connector holder allows for both standardization and flexibility. For instance, the holder may be fabricated to a variety of common shapes, sizes and configurations to accommodate standard shapes and sizes of clips or clamps used across various vehicle platforms. Finally, the block connector holder can itself be used as an attachment point for a single wire harnesses or other electrical component.

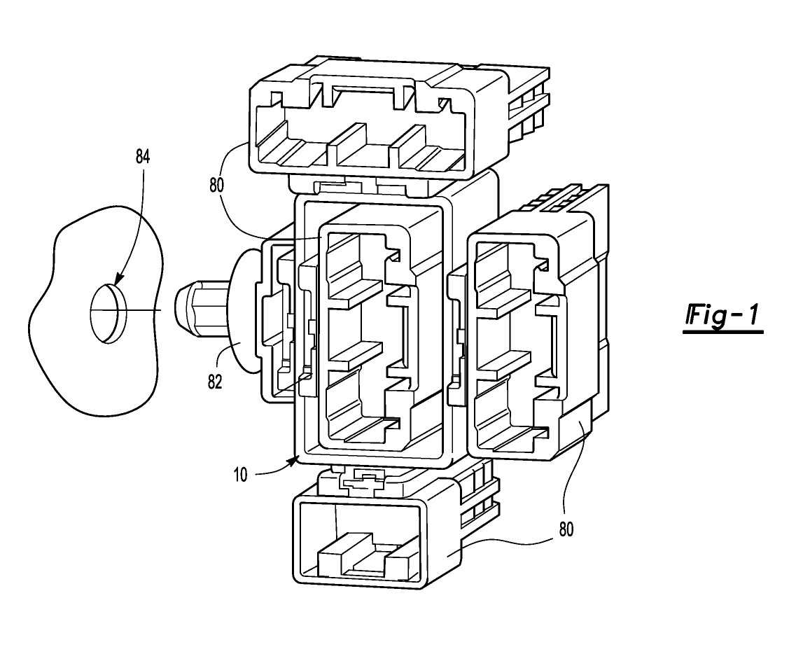

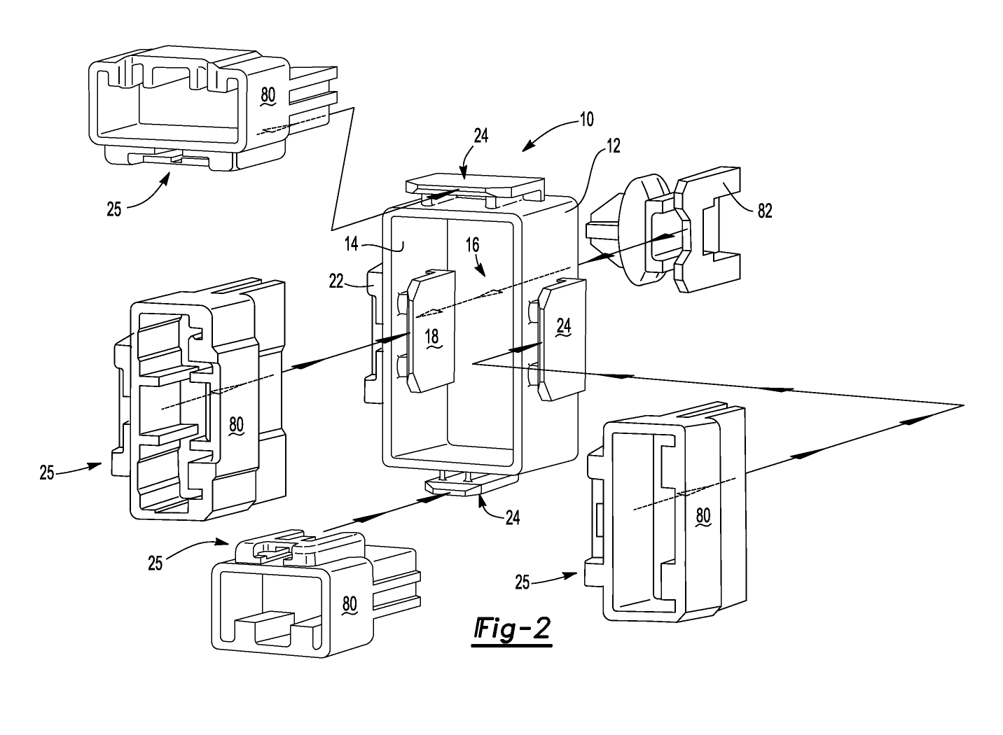

FIG. 1 generally depicts a block connector holder assembly in accordance with one or more embodiments of the present invention. FIG. 2 is an exploded view of the block connector holder assembly of FIG. 1. The block connector holder assembly as shown in FIGS. 1 and 2 includes a block connector holder 10, one or more block connectors 80, an attachment clip 82, and a vehicle attachment point 84. The block connector holder assembly may be used to attach one or more electrical components to a single vehicle attachment point 84 within an automotive vehicle. As further shown, the block connector holder assembly 10 may accommodate block connectors 80 of various shapes and sizes.

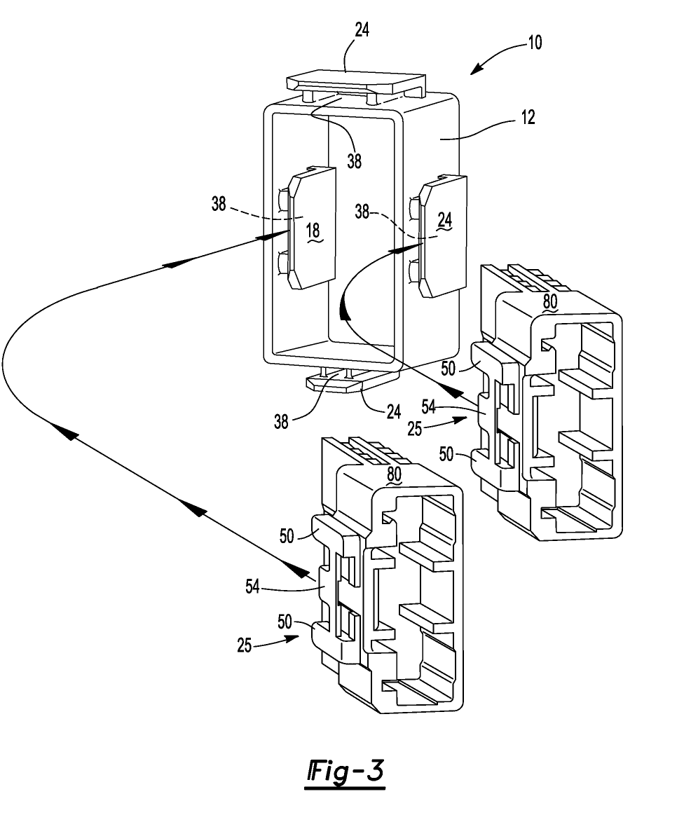

FIG. 3 is an isometric view of the block connector holder 10 in accordance with one or more embodiments of the present invention. As illustrated in FIGS. 1-3, the block connector holder 10 generally includes a housing 12 having an open rectangular parallelepiped shape. The housing 12 includes an interior surface 14 defining an interior space 16 and an exterior surface 20. The interior surface 14 may include an interior attachment structure 18 adapted to secure a block connector 80 within the interior space 16 of the housing 12. The exterior surface 20 includes a housing attachment structure 22 and one or more exterior attachment structures 24. The housing attachment structure 22 is adapted to secure the housing 12 to an attachment clip 82. The attachment clip 82 can be used to attach the block connector holder assembly to a vehicle attachment point 84 of a structure such as an automotive vehicle. The one or more exterior attachment structures 24 are adapted to secure one or more block connectors 80 about the exterior surface 20 of the housing 12. While FIG. 1 shows block connectors 80 secured to the interior attachment structure 18 and the exterior attachment structures 24, said attachment structures 18,24 are not limited to securing block connectors, but rather may attach a variety of types of electrical and/or mechanical components including wiring harnesses, clips, clasps, and other block connector holders.

The block connector holder 10 of FIG. 3 includes multiple attachment structures 18,22,24 integrally molded to the housing 12. As shown, the interior attachment structure 18 and the exterior attachment structures 24 may be male-type connectors adapted to be slidably inserted into a female-type connector on a wire harness or other electrical component. The arrows of FIG. 3 indicate one possible method of attachment to the attachment structures 18,24 which includes movement of a block connector in the direction of the arrows. The housing attachment structure 22 may also be a female-type connector compatible with the male-type connectors described above, such that an exterior attachment structure 24 of a first block connector holder can be attached to the housing attachment structure 22 of a block connector holder. In alternative embodiments, either or both the interior attachment structure and exterior attachment structures may be female-type connectors. In a further alternative, the housing attachment structure may be a male-type connector.

Returning to FIG. 1, the block connector holder 10 is shown with a plurality of block connectors 80 attached thereto. As shown, the block connector holder 10 may accommodate up to four block connectors 80 via the interior attachment structure 18 and the three exterior attachment structures 24. The block connector holder 10 is not limited to use with block connectors 80, but may also accommodate other components including harnesses, clips and relays, as well as other types of components used in automotive vehicles. The block connectors 80 are attachable to the interior attachment structure 18 and the exterior attachment structures 24 via an attachment point 25, which may be a female-type attachment structure similar to the housing attachment structure 22. The female-type attachment structure may be integrally molded to the block connector 80 or otherwise attached thereto.

The block connector holder 10 may be fabricated using an injection molding process. Preferred materials used in the fabrication of the block connector holder 10 include durable synthetic materials such as polypropylene, Nylon 6-6, or PA6-6. As an alternative to injection molding, other processes such as thermoforming, rotational molding, or blow molding could also be used produce the block connector holder 10.

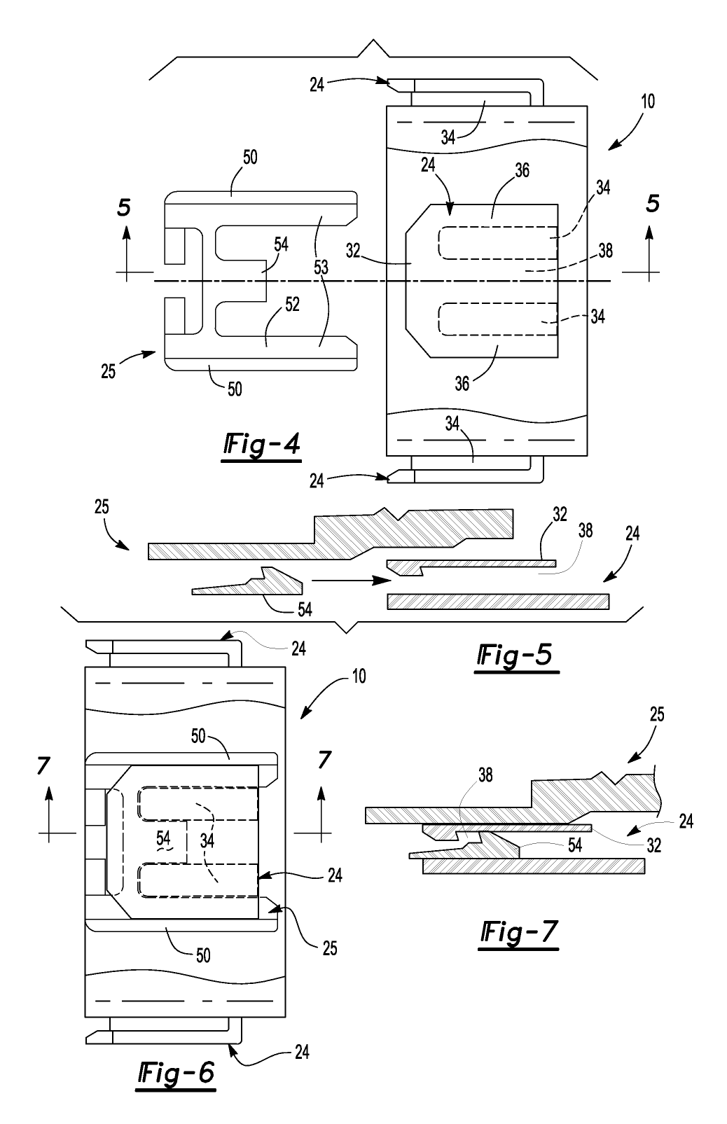

FIGS. 4-7 provide detailed illustrations of the attachment structures 18,24 and complementary attachment points 25 and illustrate how complementary attachment points 25 can be slidably inserted to attach to the attachment structures 18,24. The interior attachment structure 18 and the exterior attachment structures 24 are configured to attach to any clip, clamp, holder, or electrical component having a complimentary attachment point 25. Attachment to the structure of FIG. 1 may be accomplished by slidably inserting the attachment structure 18,24 into the complementary attachment point 25. The complementary attachment point 25 shown in FIGS. 4-7 is a female-type connector of the clip, clamp, holder, or electrical component; however, a complementary attachment point can include a male-type connector or other connector systems. Likewise, the housing attachment structure 22 may be configured to attach to a complementary attachment point 25 which may include any clip, clamp, holder, or electrical component having a complimentary male-type connector. Similarly, this may be accomplished by slidably inserting the male-type connector of the clip, clamp, holder or electrical component into the housing attachment structure 22.

Referring to FIGS. 2-7, the interior surface 14 is defined by the interior surfaces of each of the four walls of the housing 12. Each wall is positioned perpendicular to two adjacent walls to define a rectangular interior space 16. One or more of the walls may include an interior attachment structure 18. In at least one alternative embodiment, the interior surface includes two or more interior attachment structures for housing multiple electrical components within the interior space 16. In another alternative embodiment, the interior surface does not include any interior attachment structures. In another alternative embodiment, the housing does not include an interior space.

The exterior surface 20 of the housing 12 may include one or more attachment structures. As shown, the exterior surface of three of the four walls may include an exterior attachment structure 24. The exterior surface of the remaining wall may include a housing attachment structure 22. The attachment structures may have differing sizes or orientations to accommodate different structures. Attachment structures may also have the same sizes or orientations. As seen in FIGS. 2 and 3, the exterior attachment structures 24 may be of differing widths. For example, two of the exterior attachment structures may be 17-millimeters wide and one exterior attachment structure may be 9-millimeters wide.

FIG. 4 is a right side view of the block connector holder of FIG. 1, including a complementary attachment point 25 aligned and disengaged from an attachment structure 18,24. FIG. 5 is a cross-sectional view, taken along line 5-5, of the complementary attachment point 25 and the attachment structure 18,24 shown in FIG. 4. As shown, the attachment structure 18,24 and the complementary attachment point 25 are of the appropriate size, shape and orientation to slidably engage with one another. FIG. 6 is a right side view of the block connector holder of FIG. 1, including a complementary attachment point 25 engaged with an attachment structure 18,24. FIG. 7 is a cross-sectional view of the complementary attachment point 25 and the attachment structure 18,24 of FIG. 6, taken along line 7-7.

As shown in FIGS. 4-7, The interior and exterior attachment structures 18,24 may comprise an insert 32 and two supports 34. The two supports 34 extend perpendicularly from the interior surface 14 and toward the interior space 16. The two supports 34 connect the underside of the insert 32 to a surface of the housing 12, and act to separate the insert 32 from surface of the housing 12. The two supports 34 are spaced apart from the edges of the insert 32 and from one another so as to define two outer channels 36 and an inner channel 38 between the insert 32 and the interior surface 14.

The attachment point 25 may comprise two side members 50 and a W-shaped cover 52, perpendicular to and connecting the two side members 50. The W-shaped cover 52 may include two outer legs 53 and an inner leg 54. An outer edge of each outer leg 53 may be integral with a side member 50. In at least one embodiment, the housing attachment structure 22 has a shape and structure similar to the attachment point as described hereinabove. The attachment point 25 may be a female-type attachment structure adapted to receive a male-type attachment structure, such as the attachment structure 18,24. When slidably attached, the insert 32 of the exterior attachment structure 24 is generally disposed within attachment point 25, the outer legs 53 of the attachment point 25 are generally disposed in the outer channels 36 of the attachment structure 18,24 and the inner leg 54 of attachment point 25 is generally disposed within the inner channel 38 of the attachment structure 18,24.

Alternative embodiments of a block connector holder are contemplated. One such alternative embodiment may include a housing of a non-parallelepiped shape, such as a cylindrical shape, a cube shape, a triangular shape, or a hexagonal shape. Another such alternative embodiment may include one or more different attachment structures or other means of attachment. For example, in one contemplated embodiment, one or more electrical components may be integrally molded to the housing. In yet another alternative embodiment, an electrical component comprises the housing of the block connector holder itself and includes a housing attachment structure and one or more exterior attachment structures on the exterior surface thereof.

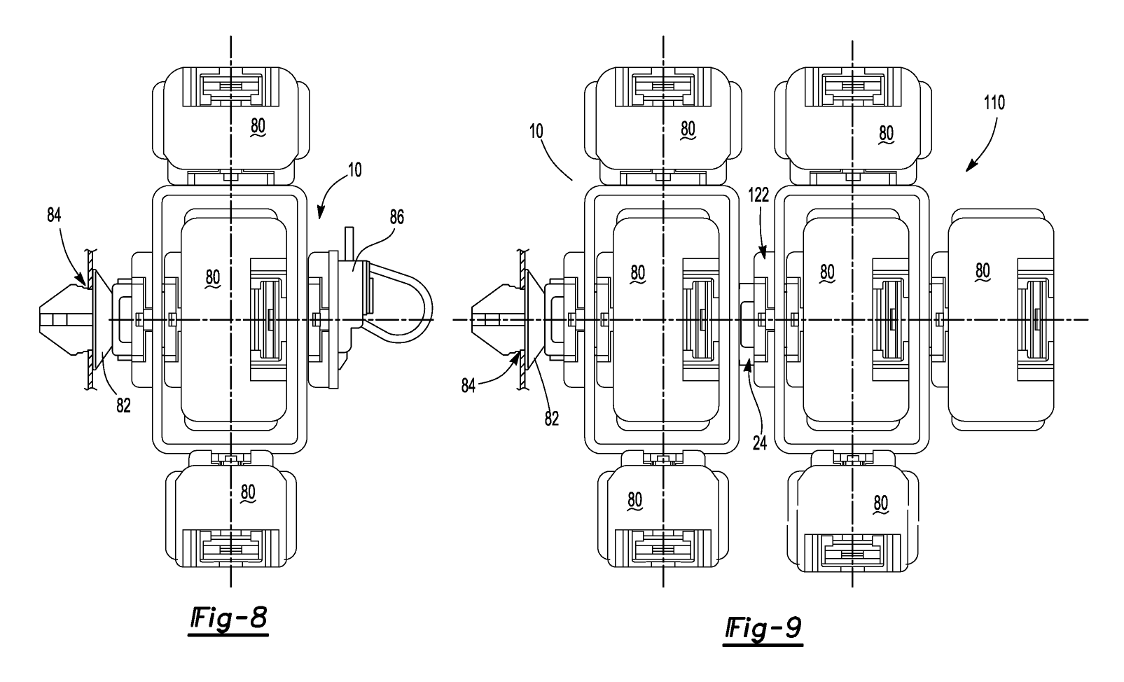

FIG. 8 is a front view of a block connector holder assembly in accordance with an embodiment of the present invention. This embodiment show three block connectors 80, an attachment clip 82, and a wire harness clamp 86 attached to the attachment structures 18,22,24 of the block connector holder 10.

FIG. 9 is a front view of two block connector holders in accordance with an embodiment of the present invention. This embodiment shows a second block connector holder 110 attached to a first block connector holder 10. The housing attachment structure 122 of the second block connector 110 is shown slidably engaged to an exterior attachment structure 24 of the first block connector holder 10.

In still another contemplated embodiment, two or more block connector holders may be configured to attach to a holder housing structure. The holder housing structure is larger than the block connector holders housed therein. The holder housing structure may be box-shaped and may be removably attachable to a vehicle attachment point 84 at one or more locations within a vehicle or, alternatively, may be permanently fixed to a location within the vehicle. Use of the holder housing structure allows multiple block connector holders, and thus many electrical components to be attached to a single area within a vehicle.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A block connector holder, comprising:
a housing including
an exterior surface having one or more exterior attachment structures; and
an interior surface, opposite the exterior surface, defining an interior space, the interior surface including an interior attachment structure;
wherein, an electrical component is attachable to each of the one or more exterior attachment
structures and the interior attachment structure.

2. The block connector holder of claim 1, wherein the block connector holder further comprises a housing attachment structure on the exterior surface.

3. The block connector holder of claim 2, wherein the housing attachment structure is removably attachable to an attachment component on a surface to secure the block connector holder to the surface.

4. The block connector holder of claim 3, wherein the housing attachment structure is slidably attachable to the attachment component.

5. The block connector of claim 3, wherein the housing attachment structure is a female-type attachment structure.

6. The block connector of claim 3, wherein the attachment component is a trim clip.

7. The block connector holder of claim 1, wherein the housing is parallelepiped in shape.

8. The block connector holder of claim 1, wherein the exterior surface includes exactly three exterior attachment structures.

9. The block connector holder of claim 1, wherein each of the one or more exterior attachment structures is removably attachable to a block connector.

10. The block connector holder of claim 1, wherein the interior attachment structure is removably attachable to a block connector such that the attached block connector is generally disposed within the interior space.

11. A vehicle comprising:
a vehicle interior including an attachment point; and
a block connector holder, including:
an exterior surface having one or more exterior attachment structures; and
an interior surface having an interior attachment structure;
wherein an electrical component is attachable to each of the interior attachment structure and the one or more exterior attachment structures;
wherein, the block connector holder is attachable to the attachment point.

12. The vehicle of claim 11, further including an attachment component, wherein the attachment component connects an exterior attachment structure of the one or more exterior attachment structures to the attachment point.

13. The vehicle of claim 12, wherein the attachment structure is a clip-like structure.

14. A block connector assembly comprising:
(a) an attachment component affixed to a vehicle, the attachment component including a first housing attachment structure;
(b) a block connector holder including:
a. an exterior surface having a second housing attachment structure and one or more exterior electrical component attachment structures; and
b. an interior surface opposite the exterior surface, the interior surface including an interior electrical component attachment structure;
(c) an electrical component;
(d) wherein the block connector holder is removably attachable to the attachment component by attaching the first housing attachment structure to the second housing attachment structure; and
(e) wherein the electrical component is removably attachable to the block connector holder by attaching the electrical component to one of either the interior electrical component attachment structure or the one or more exterior electrical component attachment structures.
